(19) United States
(12) Patent Application Publication
(10) Pub. No.: US 2008/0072833 A1
(43) Pub. Date: Mar. 27, 2008

(54) Outdoor pet litter box

(76) Inventors: John Meeks, Bel Air, MD (US); Anthony E. Cerino, Jarrettsville, MD (US)

Correspondence Address: LITMAN LAW OFFICES, LTD., P.O. BOX 15035, CRYSTAL CITY STATION, ARLINGTON, VA, 22215, US

(21) Appl. No.: 11/515,948

(22) Filed: Sep. 6, 2006

(51) Int. Cl. A01K 29/00

(52) U.S. Cl. 119/166

(57) ABSTRACT

The outdoor pet litter box provides a tray adapted for outdoor usage that defines an open area therein for receiving soil and live grass. The tray, soil and live grass may be used for the collection of excretory waste produced by a pet animal. The tray includes a base plate and at least one sidewall extending around the base plate. At least one post is mounted on the base plate adjacent the sidewall and extends upwardly therefrom to support a roof. The roof at least partially covers the open area and, preferably, is a gabled roof having a rear roof portion and a front roof portion, with the front roof portion being pivotally mounted to the rear roof portion, allowing for adjustable shade over the tray.

### BACKGROUND OF THE INVENTION

1. Field of the Invention

The present invention relates to pet accessories, and particularly to an outdoor pet litter box that includes a tray for accommodating live grass and a hinged gable roof.

2. Description of the Related Art

Pets, such as dogs, that cannot use indoor toilet facilities must be placed outdoors in order to deposit their excretory waste. Dogs are typically walked on a leash by their owners to deposit their waste on the ground. Taking a dog for a walk, however, is not always convenient, and some pet owners, such as the elderly and invalids, may be incapable of walking their dogs outside. One solution to this problem is releasing the dog into an enclosed outdoor area, such as a backyard. However, some homes, such as apartments, for example, do not have back yards or other enclosed outdoor areas for the release of animals therein.

Litter boxes, typically including a tray for receiving waste, have been used to collect animal waste indoors. Such trays often include some sort of artificial covering, which may simulate grass, or an absorbent layer, both of which may be subsequently removed and cleaned. However, these litter boxes are designed for indoor usage, and although cleanable, the odors and bacteria typically associated with animal excretory waste remain present in the pet owner's home. Further, the cleaning of the tray and artificial covering provides unsanitary, hazardous and undesirably messy conditions for the animal owner.

Although such litter boxes may be positioned outdoors, on a balcony or patio, for example, the litter box must still be cleaned, and some animals may object to the use of such a litter box, as animals often have an instinctive preference to urinate and defecate on grass. It would be desirable to provide an outdoor tray that is adapted for the receipt of natural live grass, providing a natural environment for the elimination of pet waste.

Further, a typical litter box or tray placed outdoors, on a patio or balcony, for example, will be exposed to the elements. Direct sunlight can cause the defecation received within the tray to heat, which may result in the breeding of harmful bacteria. In addition, on hot days, forcing the pet animal to spend an extended time in direct sunlight can cause injury to the animal. Likewise, during inclement weather, such as rain or snow, the animal could become ill or otherwise injured by being forced to eliminate in such an outdoor tray. It would be preferable to provide a covering for the tray, protecting both the pet animal and the grassy surface from the elements.

None of the above inventions, taken either singly or in combination, is seen to describe the instant invention as claimed. Thus, an outdoor pet litter box solving the aforementioned problems is desired.

### SUMMARY OF THE INVENTION

The outdoor pet litter box provides a tray adapted for outdoor usage that defines an open area for receiving soil and live grass. The tray, soil and live grass may be used for the collection of excretory waste produced by a pet animal. The tray includes a base plate, having an upper surface and a lower surface, and at least one sidewall extending around the periphery of the base plate. The open area is defined by the at least one sidewall and the base plate. Preferably, the base plate has a substantially rectangular contour, and the at least one sidewall includes a pair of laterally opposed sidewalls and a pair of longitudinally opposed sidewalls.

At least one post is mounted on the base plate adjacent the sidewall extends upwardly therefrom to support a roof. Preferably, a pair of posts are provided, with each post being positioned substantially central with respect to a respective one of the longitudinally opposed sidewalls. The roof at least partially covers the open area and, preferably, includes a rear roof portion and a front roof portion, with the front roof portion being pivotally mounted to the rear roof portion, allowing for adjustable coverage over the tray.

Further, a plurality of wheels may be provided, with each wheel being mounted to the lower surface of the tray. The plurality of wheels may, preferably, be castor-type wheels. In addition, the tray may be adapted for the receipt of potted plants or other types of flora.

These and other features of the present invention will become readily apparent upon further review of the following specification and drawings.

### BRIEF DESCRIPTION OF THE DRAWINGS

FIG. 1 is an environmental, perspective view of an outdoor pet litter box according to the present invention, in use on an outdoor floor surface.

FIG. 2 is an environmental, perspective view of the outdoor pet litter box according to the present invention, in a ground-mounted configuration.

FIG. 3 is an exploded perspective view of the outdoor pet litter box according to the present invention.

FIG. 4 is a partial perspective view of an alternative embodiment of the outdoor pet litter box according to the present invention.

Similar reference characters denote corresponding features consistently throughout the attached drawings.

### DETAILED DESCRIPTION OF THE PREFERRED EMBODIMENTS

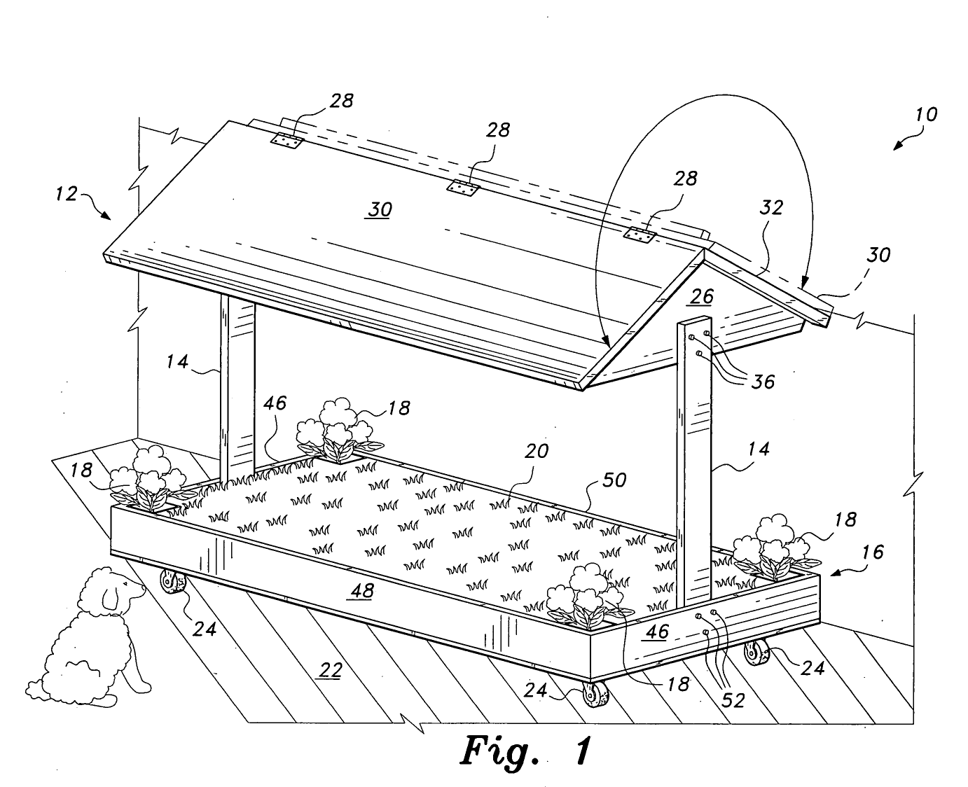

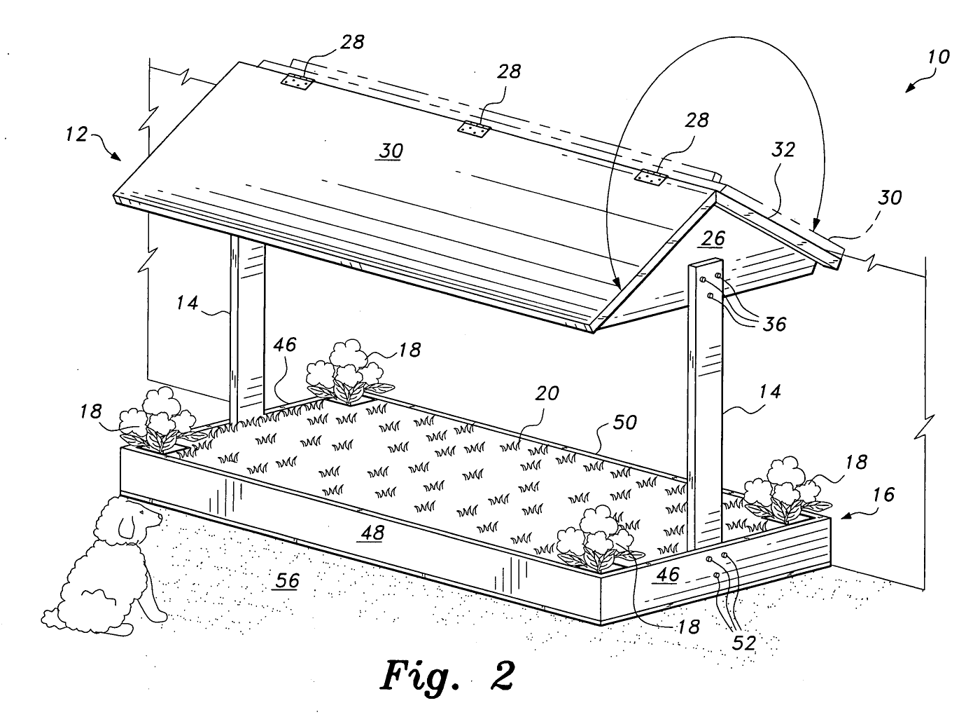

As shown in FIG. 1, the present invention is directed towards an outdoor pet litter box 10 including a tray 16, which is adapted for outdoor usage. In FIG. 1, the outdoor pet litter box 10 is positioned on an outdoor floor surface 22, such as an outdoor patio, balcony, or porch. As will be described below, with particular reference to FIG. 2, the outdoor pet litter box 10 can alternatively be positioned on a ground surface, such as is commonly found in the backyard of a home. Tray 16 defines an open area therein for receiving soil and live grass 20, e.g., turf that might be provided by landscapers or turf farms. The tray 16, soil, and live grass 20 may be used for the collection of excretory waste produced by a pet animal, such as the exemplary dog shown in FIG. 1.

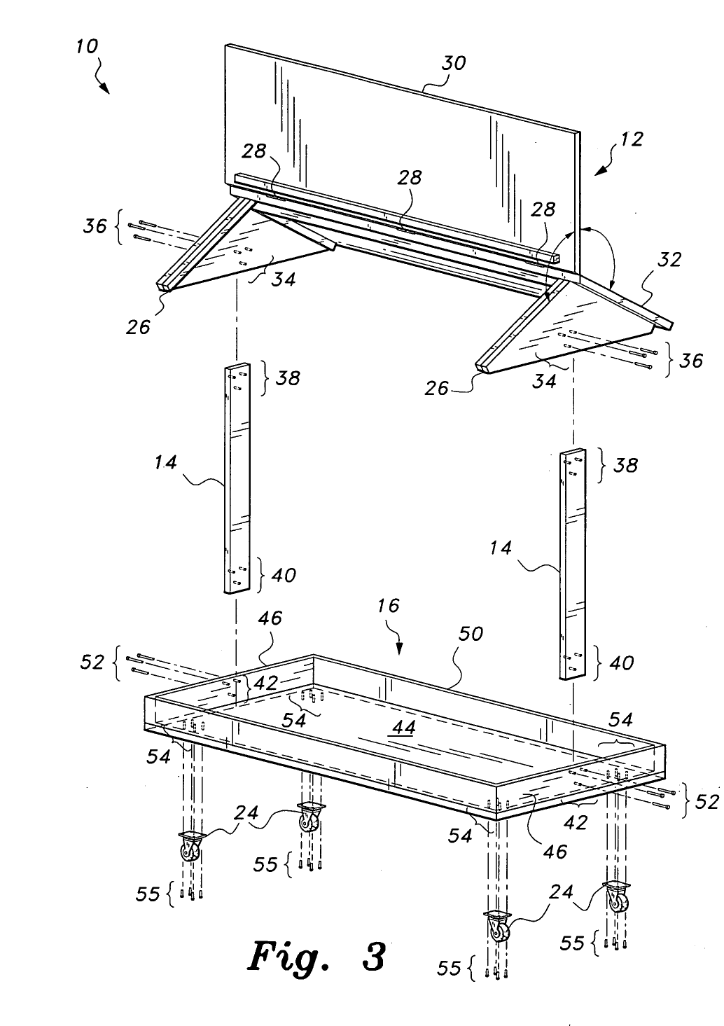

The outdoor pet litter box 10, as shown, may further include potted plants 18 or any other desired flora for producing a comfortable and aesthetically desirable environment for the animal to deposit its waste. A pair of posts 14 are mounted to tray 16 (to be described in greater detail below) for the support of a gabled roof 12. As will be described in greater detail below, particularly with reference to FIG. 3, the roof 12 includes a front roof portion 30 and a rear roof portion 32 extending to opposite sides of the ridge. Front roof portion 30 is pivotally mounted on rear roof portion 32, allowing the front roof portion 30 to provide user-selectable levels of coverage for tray 16. As indicated by the directional arrow in FIGS. 1 and 2, front roof portion 30 may be supported on either the front edge of gable end plate 26 (to be described in detail below), or may be selectively rotated to rest on rear roof portion 32. The front roof portion 30 may be positioned in an open configuration, allowing exposure of the grass, soil and tray to sunlight, or, alternatively, front roof portion 30 may be positioned in a closed configuration, providing full coverage of the tray 16 to protect the grass 20, and the pet animal from the elements.

As shown in FIG. 3, the tray 16 includes a floor or base plate 44, which may have any desired size and contour. In the preferred embodiment, however, base plate 44 is preferably substantially rectangular in contour, and is approximately two feet wide and approximately four feet long. Tray 16, posts 14 and roof 12 may be formed from any suitable material.

At least one sidewall is mounted about the periphery of the base plate 44. In the rectangular preferred embodiment, illustrated in FIG. 3, the at least one sidewall includes longitudinally opposed sidewalls 46, front sidewall 48 and rear sidewall 50, mounted along the perimeter of base plate 44 and projecting upwardly therefrom. The sidewalls and base plate 44 define the open area of tray 16 for the reception of soil and grass 20 and potted plants 18.

Each of the posts 14 has an upper end and a lower end, with at least one opening 38 being formed through the upper end and at least one opening 40 being formed through the lower end. In FIG. 3, three of each such openings are shown. However, it should be understood that this is for exemplary purposes only, and any desired number of openings may be formed through posts 14. Each post 14 is mounted on base plate 44 adjacent a respective one of the longitudinally opposed sidewalls 46.

In the preferred embodiment, each post 14 is positioned substantially central with respect to the corresponding sidewall 46, and extends upwardly from base plate 44. It should be understood that a pair of posts 14 are included in the preferred embodiment. However, any suitable number of posts 14 may be mounted on base plate 44 to support roof 12.

Openings 42, corresponding to openings 40, are formed through each sidewall 46, and fasteners 52 are received through the openings 40 and 42 to secure the posts 14 to the corresponding sidewalls 46. Fasteners 52 may be screws, bolts or any other suitable fasteners.

In the preferred embodiment, roof 12 includes a pair of gable end plates 26, as shown. Each end plate 26 is mounted on the upper end of a corresponding one of the posts 14. Each end plate 26 has at least one opening 34 formed therethrough, corresponding to openings 38 formed through the upper ends of posts 14. Fasteners 36, similar to fasteners 52, are received through openings 34 and 38 to secure the end plates 26 to the posts 14.

Each end plate 26, in the preferred embodiment, is triangular and has an upper front edge and an upper rear edge for supporting, respectively, the front roof portion 30 and the rear roof portion 32. In the preferred embodiment, end plates form the gabled roof structure shown in the drawings.

Preferably, rear roof portion 32 is fixed to the upper rear edges of end plates 26, and a rear edge of front roof portion 30 is pivotally secured to a front edge of the rear roof portion 32, as shown. Any suitable pivotal fastener may pivotally join the front edge of rear roof portion 32 to the rear edge of front roof portion 30. However, in the preferred embodiment, a pair of hinges 28, as shown, are utilized.

In addition, a plurality of wheels 24 may be mounted to the lower surface of base plate 44, allowing the outdoor pet litter box 10 to be easily transported and selectively positioned. In the preferred embodiment, wheels 24 are castors, each being secured to the base plate 44 by at least one fastener 55, similar to fasteners 52 and 36. Corresponding openings 54 are formed through base plate 44, as shown, for receiving fasteners 55 and releasably securing castors 24 to the lower surface of base plate 44.

In the embodiment of FIG. 2, wherein the outdoor pet litter box 10 is mounted on a ground surface, such as in a backyard or in a garden, wheels 24 are removed, allowing for the secure positioning of the pet litter box 10 on the ground surface 56.

It should be understood that outdoor pet litter box 10 may further include any desired design features or ornamentation, and that multiple pet litter boxes 10 may be arranged in any suitable environment, such as that shown in FIG. 2, for decorative or gardening purposes.

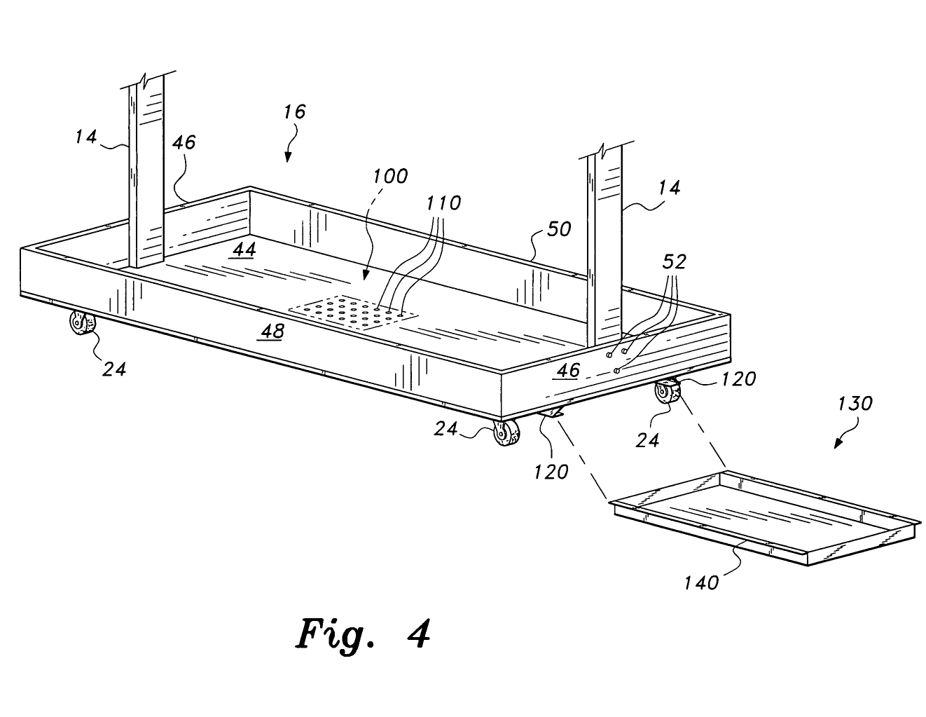

In the alternative embodiment shown in FIG. 4, an optional pan 130 is provided for receiving waste water, urine or other liquids that may pass through turf 20. A plurality of holes 110 are formed through base plate 44. Preferably, holes 110 are formed through a substantially central region 100 of base plate 44. In the preferred embodiment, about twenty-four holes 110 are formed through region 100, and each hole 110 is circular with a diameter of approximately ¼ of an inch. Region 100 is preferably substantially square in contour, with a width of approximately twelve inches, and a length of approximately twelve inches.

Z-shaped brackets 120 are mounted to the lower surface of base plate 44, for releasably receiving rim 140 of pan 130, which is slidably and releasably mounted on the Z-shaped brackets 120. Z-shaped brackets 120 removably and slidably mount pan 130 to the underside of base plate 44 to catch fluids passing through holes 110. Further, a stopping member may be mounted on one end of the lower surface of base plate 44 (the leftmost end in the exemplary arrangement shown in FIG. 4) to prevent movement of pan 130 beyond the periphery of base plate 44.

Z-shaped channels 120 are may be formed from any suitable material. However, in the preferred embodiment, each channel 120 is formed from aluminum. Pan 130 may be formed from any suitable material, and preferably has a substantially rectangular cross-sectional contour, with a length of approximately 23½ inches, a width of approximately sixteen inches and a height of approximately ¾ of an inch.

It is to be understood that the present invention is not limited to the embodiments described above, but encompasses any and all embodiments within the scope of the following claims.

We claim:

1. An outdoor pet litter box, comprising:
a tray having a base plate and a peripheral sidewall extending around the base plate, the base plate and the sidewall defining an open area adapted for receiving turf;
at least one post mounted to the base plate adjacent the sidewall and extending upwardly therefrom; and
a roof mounted to an upper end of the at least one post, the roof at least partially covering the open area of the tray, wherein the outdoor pet litter box is adapted for being placed outdoors, the tray and the turf being adapted for the collection of excretory waste produced by a pet animal.

2. The outdoor pet litter box as recited in claim 1, wherein said at least one post comprises first and second posts, the first and second posts being mounted diametrically opposite one another on said base plate.

3. The outdoor pet litter box as recited in claim 2, wherein said base plate has a substantially rectangular contour and said peripheral sidewall comprises a pair of laterally opposed sidewalls and a pair of longitudinally opposed sidewalls.

4. The outdoor pet litter box as recited in claim 3, wherein said first and second posts are each positioned substantially central to a respective one of said pair of longitudinally opposed sidewalls.

5. The outdoor pet litter box as recited in claim 2, wherein said roof comprises a gable roof having a ridge extending between said posts and a front roof portion and a rear roof portion extending to opposite sides of the ridge, a rear edge of said front roof portion being pivotally mounted to a front edge of said rear roof portion.

6. The outdoor pet litter box as recited in claim 5, further comprising a pair of gable end plates mounted on said first and second posts, respectively, each of said first and second end plates having an angled front edge and an angled rear edge, the rear roof portion being supported by the angled rear edges, and the front roof portion being supported by the angled front edges when the front roof portion is in a closed configuration.

7. The outdoor pet litter box as recited in claim 1, further comprising a plurality of wheels mounted on the lower surface of said base plate.

8. The outdoor pet litter box as recited in claim 7, wherein each of said plurality of wheels comprises a castor.

9. The outdoor pet litter box as recited in claim 1, wherein said base plate has a plurality of holes defined therein, said base plate defining a lower surface, the litter box further comprising a pan slidably mounted below the holes defined in said base plate in order to catch liquids and waste draining through said turf and the plurality of holes defined in said base plate.

10. The outdoor pet litter box as recited in claim 9, further comprising a pair of brackets mounted to the lower surface of said base plate and defining tracks, said pan being slidable in the tracks.
